(19) United States
(12) Patent Application Publication
(10) Pub. No.: US 2012/0204627 A1
(43) Pub. Date: Aug. 16, 2012

(54) Method for Establishing Cavitation in Hydrostatic Devices and Control Device

(75) Inventors: Thomas Anderl, Neu-Ulm (DE); Matthias Mueller, Langenau (DE); Michael Mast, Schemmerhofen (DE)

(73) Assignee: Robert Bosch GmbH, Stuttgart (DE)

(21) Appl. No.: 13/372,831

(22) Filed: Feb. 14, 2012

(30) Foreign Application Priority Data
Feb. 16, 2011 (DE) 10 2011 011 348.7

(51) Int. Cl. G01N 29/02

(52) U.S. Cl. 73/64.53

(57) ABSTRACT

A method for detecting cavitation in a hydrostatic system includes capturing an oscillation typical for the cavitation from a pressure captured over time. Furthermore, the method includes establishing an evaluation variable for cavitation on the basis of the captured oscillation. Additionally, the method includes comparing the evaluation variable to a comparison value.

This application claims priority under 35 U.S.C. §119 to German patent application no. DE 10 2011 011 348.7, filed Feb. 16, 2011 in Germany, the disclosure of which is incorporated herein by reference in its entirety.

### BACKGROUND

The present disclosure relates to a method for establishing cavitation in a hydrostatic system and to a control device, which applies such a method, for a hydrostatic system.

Cavitation refers to the formation and subsequent sudden condensation of vapor bubbles in flowing liquids, caused by abrupt changes in velocity (cavitation). Cavitation occurs in hydrostatic devices and systems, such as e.g. in hydrostatic pumps, when these are operated in overload operation or with excessive rotational speeds. Since the bursting of the vapor bubbles leads to the development of very loud noises and also to damage to the hydrostatic devices and systems, there is a significant amount of interest in identifying cavitation and, in such a case, switching off or reducing the load on the hydrostatic system before the hydrostatic system can be damaged.

The European patent EP 1 333 276 B1 discloses a method for detecting cavitation, which is based on oscillation measurements on the housing of a hydrostatic device. Here, a mechanical oscillation sensor, which measures oscillations in a first direction, and a second mechanical oscillation sensor, which measures oscillations in a second direction, are used to capture two oscillations, wherein the ratio of the two oscillations allows conclusions to be drawn in respect of the cavitation in the hydrostatic device. A disadvantage of this method is that two oscillations have to be measured here in order to establish the cavitation and that the cavitation detection requires additional sensors for the hydrostatic device. Furthermore, the two oscillation sensors require additional space and increase the weight of the hydrostatic device with additional sensors.

### SUMMARY

The object of the disclosure is to develop a method and a control instrument for identifying cavitation, which can robustly detect cavitation, yet does not require expensive and complicated sensors and only modifies the hydrostatic system to a small extent.

The object is achieved by the method according to the disclosure for detecting cavitation described herein and by the control instrument according to the disclosure.

The method according to the disclosure for detecting cavitation in a hydrostatic system comprises: the pressure of the pressurized-means liquid in the hydrostatic system, i.e. the pressure curve of the pressurized-means liquid, is initially captured over time as a measured variable. Here, it is the work pressure that is referred to by pressure, i.e. the high pressure driving the hydrostatic system. In the case of a pump, it is the pressure-side pressure. Furthermore, an oscillation typical for the cavitation is captured from the captured pressure curve. Finally, an evaluation variable for cavitation is established from the captured oscillation and it is subsequently compared to a comparison value in order to make a statement in respect of the cavitation in the hydrostatic system.

The control device according to the disclosure has means that are designed to carry out the method according to the disclosure. Thus, the control device has a measurement input for reading the pressure values over time. Furthermore, the control device has an oscillation capturing device, designed to capture an oscillation in the read pressure values of the pressurized means, and an evaluation device, designed to establish an evaluation variable from the captured oscillation and for comparing the established evaluation variable to a comparison value for determining the cavitation. The evaluation device and the oscillation capturing device are preferably realized in a common control unit in the control device.

The solution of the object according to the disclosure is advantageous in that, unlike in the case of oscillation sensors in the prior art for determining mechanical oscillation, there is no need for an additional sensor for determining the cavitation since a pressure sensor is already available for controlling many hydrostatic systems. Furthermore, the method according to the disclosure only requires one measured physical variable, namely the pressure in a work line of the hydrostatic system in order to establish the cavitation therein. Such a system can easily be transferred to other hydrostatic systems with other cavitation frequencies because the frequency selection of the oscillations to be captured can be adjusted not by the structure of the oscillation sensor but by the evaluation method in the control device. In the prior art, a different oscillation sensor must be used for each hydrostatic system with its own cavitation frequency—this is expensive and involves much effort. The disclosure also includes the capture of more than one oscillation typical for the cavitation and the use of these for detecting the cavitation.

It is advantageous to capture the oscillation typical for the cavitation by frequency selection, wherein an oscillation at a frequency typical for the cavitation is captured. The typical cavitation frequencies are known for most hydrostatic systems. Thus, in the case of a hydrostatic pump, the typical frequency is the number of pistons multiplied by the rotational speed of the pump. It is possible to make a reliable statement in respect of the cavitation by capturing such a known oscillation.

It is advantageous to capture the oscillation by establishing a variable proportional to the amplitude of the oscillation over time, i.e. an oscillation amplitude curve, from the captured pressure curve. The amplitude determines the strength of an oscillation. A variable that is proportional, preferably directly proportional, thereto is thus on the one hand perfectly suited to determine the change in the strength of the oscillation and, on the other hand, is much easier to determine than the exact amplitude of the oscillation. It is self evident that this also comprises determining the exact amplitude.

Thus, it is particularly advantageous to subject the captured pressure measured values to band filtering and to establish the variable proportional to the amplitude of the oscillation on the basis of the band-pass filtered pressure values. It is particularly advantageous for hydrostatic systems with hydrostatic piston engines if, during operation, the center frequency of the frequency band of the band filter is matched to the rotational frequency of the hydrostatic piston engine multiplied by the number of pistons. The frequency band can alternatively be fixedly determined, with it being established from the rotational-frequency band of the hydrostatic piston engine multiplied by the number of pistons. Within the scope of the disclosure, band-pass filtering should not only be understood to mean isolated band-pass filtering of the pressure values, as can be realized by a Fourier filter, for example, carried out in an individual step, but rather any type of processing of the captured pressure values that achieves the effect of band-pass filtering and may, in addition to the band-pass filtering, simultaneously also carry out further processing steps for the pressure values, like determining the amplitude or a variable proportional to the amplitude.

A particularly advantageous method for band-pass filtering is to smooth the profile of the pressure values over time and to establish for each measurement time the deviation of an individual pressure value at this measurement time from the smoothed pressure value at this time, or a variable characterizing this deviation, as the variable proportional to the amplitude of the oscillation. The smoothing is preferably carried out by forming a moving average, in which the smoothed value at a point in time is established by averaging over time a number of previously measured pressure values, which were measured over a period of time.

It is furthermore advantageous if the pressure values are assumed to be zero (i.e. set to “0”) for times at which the pressure values exceed an upper pressure threshold that lies just below the pressure limitation of the hydrostatic system and/or when the pressure values drop below a lower pressure threshold that is a minimum requirement for the stable operation of the hydrostatic system and/or when the hydrostatic system is in a faulty operating state. Here, just below the pressure limitation should be understood to mean that the maximum upper pressure threshold is selected under the condition that the oscillations resulting from opening and closing a safety pressure-limiting valve in the vicinity of the opening pressure of the pressure-limiting valve (pressure limitation) are certain not to occur yet. Such an upper pressure threshold could lie in the region of 90% to 100% of the pressure-limiting pressure, preferably in a region of 95% to 99% of the pressure limitation. As a result, an erroneous detection of cavitation as a result of measured pressure oscillations resulting from the pressure-limiting valve is avoided, and so the robustness of the method is increased. Rapid pressure increases are generated during the start up of the hydrostatic system; these can also lead to transient states. As a result of the lower pressure threshold, such rapid pressure increases and transient states are not taken into account and thus they do not falsify the results of the cavitation detection. Furthermore, it can also be possible to wait a certain amount of time after the minimum pressure threshold, at which the system runs stably, is exceeded so as also to take into account in the measured pressure values transient states when the lower pressure threshold is reached. Furthermore, it is advantageous if the cavitation detection is only taken into account in specific operating modes, in which the detection works particularly robustly, more particularly in those in which the oscillation typical for the cavitation occurs.

It is particularly advantageous at this time for the variable characterizing the deviation of the pressure value at this measurement time from the smoothed pressure value to in turn also be smoothed at this time by a moving average. Hence a with respect to the amplitude of an oscillation typical for the cavitation or of a restricted frequency band typical for the cavitation can be determined without cumbersome and complex Fourier transforms. The selection of the frequency or the frequency band that will be examined is set via the smoothing-filter parameters of the two instances of smoothing. An advantageous establishing method for the variable proportional to the amplitude of the oscillation consists of smoothing the variable characterizing the deviation of the pressure value at this measurement time from the smoothed pressure value, for example by performing a moving average over one period of oscillation, and to establish this value, smoothed a second time, as the variable proportional to the amplitude of the oscillation.

It is furthermore advantageous for the evaluation variable to be established on the basis of the variable proportional to the amplitude of the oscillation. The evaluation variable could advantageously be established on the basis of the time during which the amplitude of the oscillation exceeds an amplitude threshold. Furthermore, the evaluation variable could be corrected on the basis of the time during which the amplitude of the oscillation drops below a further amplitude threshold, which lies under the amplitude threshold. The amplitude threshold and/or the further amplitude threshold are preferably established on the basis of one of the variables from the captured pressure, an applied rotational speed of a hydrostatic machine and a working volume set on the hydrostatic machine or a combination of these variables. As a result of matching the thresholds to the characteristic pressure values of a hydrostatic machine like this, it is possible to set the amplitude thresholds such that cavitation is robustly detected. This is preferably brought about by virtue of detecting when the evaluation variable exceeds the comparison value. The function of the hydrostatic system then preferably is restricted or the latter is switched off.

It is furthermore advantageous for the hydrostatic system to have a hydro-pneumatic storage and for gas influx from a gas bubble of the hydro-pneumatic storage into the pressurized-means liquid to be detected when cavitation is detected. The gas component in the pressurized-means liquid increases as a result of the influx of gas into the pressurized-means liquid and the cavitation effect increases. As a result, it is also possible to detect a defect in the hydro-pneumatic storage by detecting cavitation.

It is furthermore advantageous if the pressure in the pressurized-means liquid on the high-pressure side of the hydrostatic system is captured over time as measured variable. This is because the pressure oscillations in the hydrostatic system occur significantly more clearly on the high-pressure side in particular.

### BRIEF DESCRIPTION OF THE DRAWINGS

A preferred exemplary embodiment of the disclosure is described in the following text on the basis of the drawing. In the drawings:

FIG. 1 shows a hydrostatic device with an exemplary embodiment of the control device according to the disclosure;

FIG. 2 shows a flowchart of the exemplary embodiment of the method according to the disclosure;

FIG. 3 shows a flowchart of the steps from logic filtering;

FIG. 4 shows a flowchart of the steps of establishing the error counter;

FIG. 5a shows a diagram of the measured pressure values and the first moving averages over time;

FIG. 5b shows a diagram of the established deviations of the measured pressure values from the first moving averages and from the second moving averages over time; and

FIG. 5c shows a diagram of the error counter over time.

### DETAILED DESCRIPTION

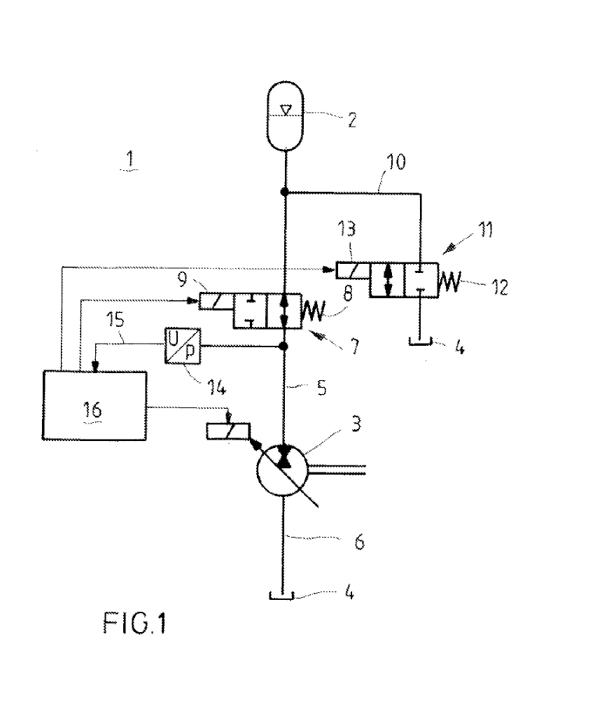

FIG. 1 shows a regenerative hydrostatic drive system 1 as a hydrostatic system. The regenerative hydrostatic drive system 1 comprises a hydro-pneumatic storage 2. The hydro-pneumatic storage 2 is embodied as a high-pressure storage and has a volume that is elastically delimited with respect to a liquid. This volume is referred to as a gas bubble and is filled with a compressible medium, usually nitrogen.

Furthermore, the regenerative hydrostatic drive system 1 has a hydrostatic machine 3, which can be operated as a pump and as a motor. The working volume of the hydrostatic machine 3 can be adjusted, and the latter is preferably designed as an axial piston engine with a swashplate-type design. The hydrostatic machine 3 is used during hydrostatic braking to suction in pressurized means from a tank volume 4 that forms a balancing volume and to deliver it against the pressure prevalent in the hydro-pneumatic storage 2. To this end, the hydro-pneumatic storage 2 is connected to the hydrostatic machine 3 by a high-pressure line 5. A low-pressure line 6 is provided for the connection between the hydrostatic machine 3 and the tank volume 4.

A shut-off valve 7 is provided in the high-pressure line 5. The valve 7 is embodied as 2/2-port directional control valve and, in a rest state, is kept in an open position by a spring 8. The valve 7 remains in this position for as long as the system operates without faults. If an error state is detected, the remainder of the regenerative hydrostatic drive system 1 can be separated from the hydro-pneumatic storage 2 by running current through an electromagnet 9 of the valve 7, said electromagnet pressing a valve piston of the valve 7 into a closed position against the force of the spring 8 when current flows through it.

Between the hydro-pneumatic storage 2 and the valve 7, a relief line 10 connecting the hydro-pneumatic storage 2 with the tank volume 4 branches off the high-pressure line 5. A vent valve 11 is arranged in the relief line 10, the former being embodied as a 2/2-port directional control valve and kept in a closed position in a rest state by means of a spring 12. If an error state is detected, for example if gas leaks into the pressurized means from the gas bubble because the gas bubble has become porous, the pressurized means of the hydro-pneumatic storage 2 can be vented into the tank volume 4 by running current through an electromagnet 13 of the vent valve 11, said electromagnet pressing a valve piston of the vent valve 11 into an open position against the force of the spring 12 when current flows through it.

In order to capture the work pressure as measured variable, a pressure sensor 14 as pressure capturing means is arranged in the work line 5, i.e. in part of the regenerative hydrostatic drive system 1 that is under high pressure, which pressure sensor is connected to a control instrument 16 acting as a control device via a first control line 15.

Hence the control instrument 16 captures the work pressure on the high-pressure side of the hydrostatic machine 3 by means of the pressure sensor 14. The control instrument 16 is designed such that the measured system pressure is used to control the system components, such as the electromagnet 9 of the valve 7, the electromagnet 13 of the vent valve 11 or an actuator 17 of the hydrostatic machine 3, which sets the working volume of the hydrostatic machine 3 and the operation thereof as a motor or pump via the angle of a swashplate of the hydrostatic machine 3. Thus, for example, the control instrument 16 establishes a pump volume to be set of the hydrostatic machine 3 operating as a pump from the measured work pressure in the work line 5 and a predetermined braking torque.

The control instrument 16 according to the disclosure is furthermore designed such that it can detect cavitation on the basis of the established work pressure in the work line 5 by carrying out the method according to the disclosure.

It is possible, in inexpedient conditions, for the gas bubble in hydro-pneumatic storages, like the hydro-pneumatic storage 2, or other interfaces between a pressurized liquid and a gas volume of other hydro-pneumatic components to become porous and leaky. Initially, this causes a little diffusion of the gas into the pressurized means. The increased amount of gas in the pressurized means leads to an increased cavitation effect in the systems connected to the hydro-pneumatic storages.

This effect is utilized in the exemplary embodiment of the disclosure. When cavitation is detected in the regenerative hydrostatic drive system 1, the conclusion is drawn that gas is leaking into the pressurized means from the gas bubble and the valve 7 is closed to prevent further gas influx into the hydrostatic machine 3. Furthermore, the vent valve 11 is opened in order to vent the hydro-pneumatic storage 2 and quash the danger of the gas bubble bursting. In the case of a hydrostatic system that no longer needs such a hydro-pneumatic storage 2 for carrying out its function, it is also possible to remove the gas diffusion into the pressurized means by relieving and separating the hydro storage 2 because the hydro-pneumatic storage 2 is separated, and this hydrostatic system continues to be operated without the hydro-pneumatic storage 2.

Cavitation causes a cavitation oscillation typical for the utilized hydro-pneumatic system. In the case of hydrostatic piston engines like the hydrostatic machine 3 in the pump operation, the typical frequency of this pressure oscillation is calculated by the number of pistons of the hydrostatic machine 3 multiplied by the rotational speed of the hydrostatic machine 3.

According to the disclosure, a defect in the gas bubble is now identified in the regenerative hydrostatic drive system 1 as hydrostatic system by a detected increase in the gas content of the pressurized means. This is detected by the increase in the cavitation in the hydrostatic machine when the latter operates as a pump. According to the disclosure, the cavitation from the pressure oscillations for the hydrostatic machine 3 in the pumping operation that are typical for the cavitation is in the process detected from the pressure oscillations in the pressurized means in the work line 5.

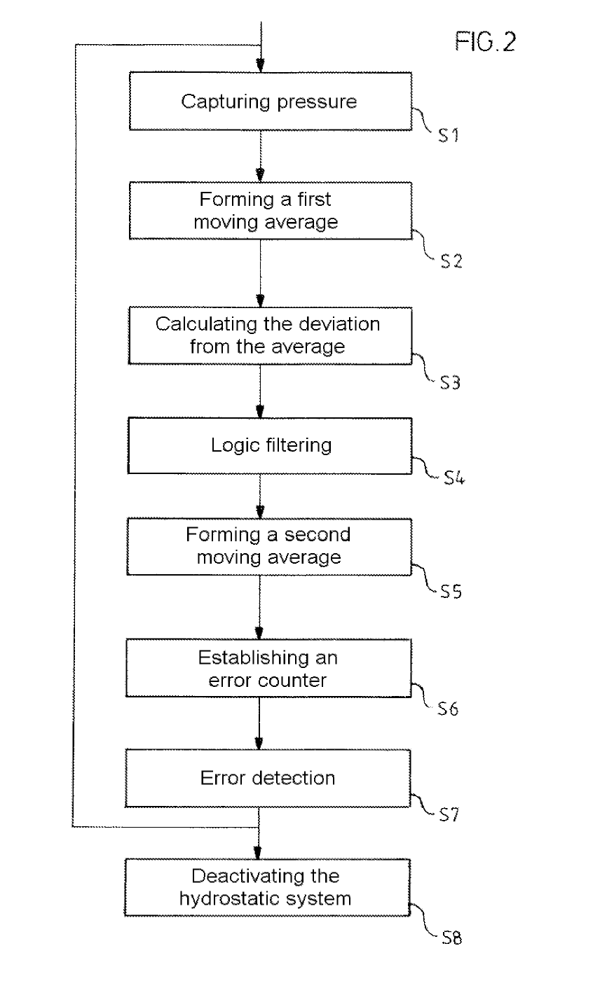

In the following text, an exemplary embodiment of the method according to the disclosure for detecting cavitation in the regenerative hydrostatic drive system 1 is described. The method is based on the time-resolved measurement of pressure values in the work line 5. The current pressure values are preferably captured by the pressure sensor 14 with a fixed sampling rate and transmitted to the control instrument 16. However, capturing the pressure over time is not restricted to this exemplary embodiment; rather, the capture can be brought about with any of the methods known to a person skilled in the art, such as analog or digital, with fixed or variable sampling rate, etc. When this application discusses a pressure value, this means the pressure value captured at a measurement time. When pressure is discussed below, this means the pressure as a measured variable. In the following text, the individual steps for processing the captured pressure are described with the aid of FIGS. 2, 3 and 4.

In a first step S1, a pressure value at a specific measurement time in the work line 5 is measured by means of the pressure sensor 14 and transmitted to the control instrument 16. The control instrument 16 has a memory, in which the captured pressure value is stored. If pressure values were already measured previously, they too are stored in the memory.

In a second step S2, a first moving average is calculated in an oscillation capturing device of the control instrument 16 for the specific measurement time. The moving average is formed by forming the average of the pressure values measured in a specific first period of time up to the specific measurement time. In the case of a fixed sampling rate with equidistant measurement times, the specific first period of time can be specified as a first number n1 of the last measured pressure values as a measurement period of time to be determined, multiplied by the sampling rate. Thus, the first moving average is formed at the specific measurement time as the average of the last n1 pressure values, which include the pressure value measured in S1. If less than n1 pressure values were captured previously, either the average is only formed over the previously captured pressure values or the pressure values occurring before these are set to a value, e.g. zero or the first measured pressure value. The selection of the specific first period of time will still be discussed in conjunction with step S3. The first moving average can be calculated quickly by storing intermediate variables in the memory. Thus, for example, the last calculated first moving average could be buffer stored, and be calculated by correction of the pressure value that is no longer taken into account and the newly added pressure value.

In step S3, the absolute deviation, i.e. the magnitude of the difference, of the pressure value captured at the specific measurement time from the first moving average established for the specific measurement time in S2 (abbreviated: absolute deviation) is calculated in the oscillation capturing device. Together, steps S2 and S3 act as a high-pass filter, which suppresses or at least attenuates all oscillations with a period of oscillation that is longer than the first specific period of time. It is for this reason that the first specific period of time is selected such that frequencies below a lower limit frequency, below which no oscillations arising as a result of cavitation are to be expected, are filtered out. As a result, due to the absolute value in S3, it is not the high-pass filtered oscillation about zero that is obtained, but rather the magnitude of this oscillation with only positive values.

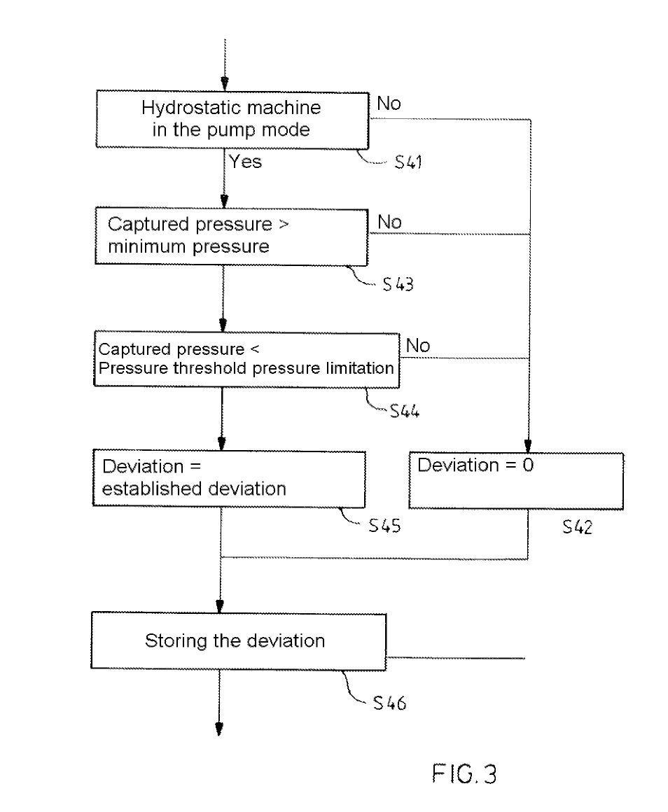

In step S4, logic filtering is additionally also carried out, which sets the absolute deviation calculated in S3 to zero in specific operating states in which oscillations that appear to be like an oscillation typical for the cavitation may occur. The logic filtering is illustrated in more detail in FIG. 3. In step S41, a check is carried out to see whether the hydrostatic machine 3 is in the pump mode. This is captured on the basis of the setting of the swashplate in the hydrostatic machine 3. If the hydrostatic machine 3 is not in the pump mode, the absolute deviation calculated in S3 is set to zero in S42. The oscillation typical for the cavitation, which is captured in this exemplary embodiment of the disclosure, is a feature of the hydrostatic machine 3 during pumping operation and therefore does not occur in other operating modes. Thus, for the robustness of the detection method for cavitation, the absolute deviation is not taken into account in operating modes in which the sought-after typical cavitation oscillation does not occur. However, if the hydrostatic machine 3 is in the pump mode, a check is carried out in S43 to see whether the pressure value captured in S1 is greater than a minimum pressure as lower pressure threshold. Here, the minimum pressure is the lowest pressure required to obtain stable operation of the regenerative hydrostatic drive system 1. When the regenerative hydrostatic drive system 1 is started up, there are oscillation components in the work pressure as a result of the great increase in pressure and transient states and these can be similar to the oscillation typical for the cavitation. Hence the deviation calculated in S3 is set to zero in S42 in a state below the minimum pressure. However, if the pressure value measured in S1 exceeds the lower pressure threshold, a test is carried out in step S44 to see whether the pressure value measured in S1 is smaller than an upper pressure threshold. The upper pressure threshold is defined just below the pressure limitation, which is fixed by the pressure-limiting valve (not shown in FIG. 1). In the region of the opening pressure, the pressure-limiting valve leads to an oscillation because it continuously opens and closes when responding. This oscillation could falsify the result of the cavitation detection and is therefore avoided by setting the absolute deviation from S3 to zero in S42 in the case of pressures above the upper pressure threshold. In the case of an opening pressure of 300 bar for the pressure-limiting valve, the upper pressure threshold is fixed at e.g. 290 bar. If the pressure value measured in S1 lies below the upper pressure threshold, the absolute deviation calculated in S3 is not modified in S45 and the unmodified deviation is stored in the memory in step S46. If the deviation is set to zero in S42, this modified deviation is stored in S46. Taking account of operating states in which the oscillation typical for the cavitation does not occur or is interfered with, can also at an earlier or later time, for example by correcting the evaluation variable or by setting the pressure value in S1 to the corresponding upper or lower pressure threshold should it be exceeded or undershot.

In step S5, a second moving average is formed at the specific measurement time. To this end, the average of the to the absolute deviations of the pressure values from the associated first moving averages is calculated, which absolute deviations are stored in the specific second period of time up to the specific measurement time in S4. These deviations for calculating the second moving average of the specific measurement time are preferably stored in the memory. The second specific period of time may, like the first specific period of time, be expressed in a fixed number of the most recently calculated absolute deviations in the case of a fixed sampling rate of the pressure values and hence of the calculated absolute deviations. The second specific period of time T2 is preferably selected as an integer multiple of half of the first specific period of time T1 in order to obtain a variable proportional to the amplitude of the oscillation with the period of oscillation T1. Thus, it is precisely the average over half a period of oscillation T1 that is formed, after which the values of the absolute deviation repeat as a result of the absolute value. T2=T1/2 is preferably selected, since this obtains a particularly high time resolution for the variable proportional to the amplitude of the oscillation. If the pressures only contained the sought-after cavitation oscillation, it would also be possible to establish a maximum value, determined in a running fashion, from the specific second period of time. However, the second moving average is additionally advantageous in that an average is taken over the amplitude oscillation of relatively high frequencies, and so these are attenuated and in part even suppressed. Thus the second moving average additionally has the property of a low-pass filter, which averages out amplitudes with oscillations with a period of oscillation less than T2.

The result of method steps S2 to S5 of the exemplary embodiment corresponds to determining a variable that is proportional to the amplitude power of the band-pass filtered pressure in the work line 5, wherein the band of the band-pass filter separates the oscillations with period of oscillations T1 to T2 from the pressure signal. The selection of T1=1/f is determined by the frequency f_{typ} typical for the cavitation in the hydrostatic machine 3 during pumping operation. Since the typical frequency f_{typ} depends on the rotational speed of the hydrostatic machine 3, T1 can be matched to the rotational speed of the hydrostatic machine 3 in order to improve the cavitation detection. However, in this exemplary embodiment T1 is selected to be fixed, wherein T1 is selected as mean period of oscillation of the oscillations of the frequency band, which is fixed by the rotational speed range for which the hydrostatic machine 3 is designed. The disclosure is not restricted to the described exemplary embodiment. Rather, all methods that establish a variable proportional to the amplitude power of the band-pass filtered pressure of the work line 5 fall within the scope of the disclosure. Here, it would also be advantageous to match the frequency band of the band-pass filter to the frequency band of the typical cavitation frequencies prescribed by the rotational-speed range of the hydrostatic machine 3.

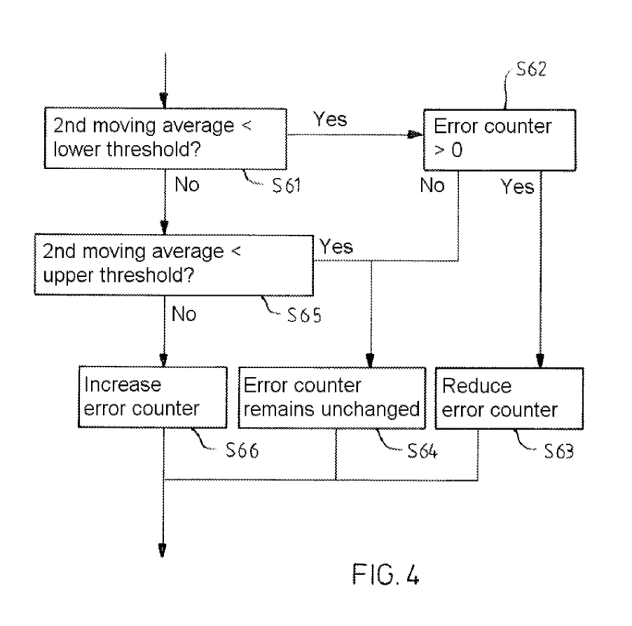

In step S6, an error counter is established as an evaluation variable on the basis of the second moving average established in step S5. The calculation of the error counter is illustrated in more detail in FIG. 4. To this end, a check is carried out in step S61 to see whether the second moving average is smaller than a lower error threshold as a further amplitude threshold. If this can be answered in the affirmative, a check is carried out in step S62 to see whether the error counter is greater than zero. If this is the case, the error counter is reduced by one counter in step S63 and if this is not the case, the error counter is left unchanged at zero in step S64. If a decision is made in S61 that the second moving average lies at or over the lower error threshold, a check is carried out in S65 to see whether the second moving average is less than an upper error threshold as an amplitude threshold. If this can be answered in the affirmative, the error counter is left unchanged in S64. If the check in S65 is answered in the negative, i.e. if the second moving average is greater than or equal to the upper error threshold, the error counter is increased by one counter in step S66.

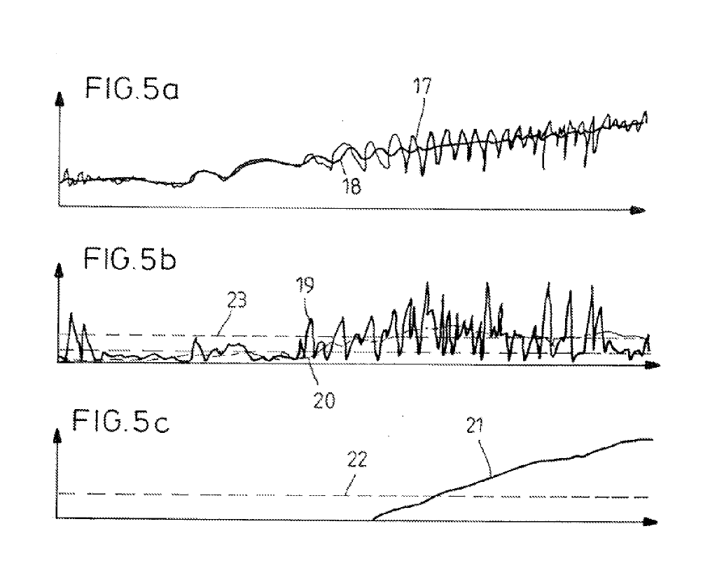

The error counter is compared to a comparison value in S7. The steps S1 to S7 are now cyclically carried out again for every new pressure value captured by the pressure sensor 14. FIGS. 5a, 5b and 5c show the captured and established variables over time. In FIG. 5a, the pressure values captured in S1 at every measurement time are plotted over time as dashed line 17 and the first moving averages established in S2 for each measurement time are plotted over time as solid line 18. In FIG. 5b, the absolute deviations established in S3 for each measurement time are plotted over time as solid line 19 and the second moving averages calculated in S5 for each measurement time are plotted over time as dashed line 20. The upper error threshold 23 and the lower error threshold 24 are also illustrated. FIG. 5c plots the error counter 21 over time and the comparison value 22.

If the error counter in S7 lies above the comparison value, cavitation is detected. In the regenerative hydrostatic drive system 1, the conclusion drawn is that the gas proportion in the pressurized means has increased and so there is cavitation in the hydrostatic machine 3. As a result, the conclusion is drawn that the hydro-pneumatic storage 2 has become leaky and gas enters the pressurized means. If the error counter in S7 is below the comparison value 22, the method returns to step S1.

In step S8, the hydro-pneumatic storage 2 is separated from the remainder of the regenerative hydrostatic drive system 1 when cavitation is detected and the hydro-pneumatic storage 2 is vented into the tank volume 4 via the vent valve 11. Hence, the remainder of the regenerative hydrostatic drive system 1 is protected from further gas influx, which could lead to damage in the hydrostatic machine 3 as a result of the cavitation. Furthermore, the hydro-pneumatic storage 2 is prevented from bursting, along with consequential damage related thereto. This allows relatively substantial damage to be identified at an early stage, before damage occurs in the regenerative hydrostatic drive system 1. In the case of the regenerative hydrostatic drive system 1, the hydrostatic machine 3 is also set to a negligible delivery volume if the error counter exceeds the comparison value because there is no further load present in the regenerative hydrostatic drive system 1 and the regenerative hydrostatic drive system 1 would only deliver into the tank volume 4 via the pressure-limiting valve. In other systems, which are not dependent on the hydro-pneumatic storage 2, it is possible only to separate the hydro-pneumatic storage from the remainder of the system, and continue to operate the latter in a restricted fashion. This is only possible as a result of the early detection of the fault in the hydro-pneumatic storage 2.

In the exemplary embodiment, the error thresholds 23 and 24 are fixedly stored in the memory of the control instrument 16. The error thresholds 23 and 24 are specifically determined by empirical means for the regenerative hydrostatic drive system 1 or for every further hydrostatic system. Here, the regenerative hydrostatic drive system 1 is operated without the occurrence of cavitation in all possible operating states in which cavitation detection is carried out, i.e. in operating states that are allowed in the logic filter in S4. Steps S1 to S5 are carried out cyclically and the second moving averages from S5 are stored. By way of example, the lower error threshold is determined from the maximum second moving averages occurring during normal operation of all aforementioned operating states. The upper error threshold is determined from the lower error threshold plus a tolerance range. In an alternative exemplary embodiment, it is possible for the error thresholds for individual operating states to be stored and hence the error thresholds can be matched depending on the currently applied operating state. The parameters describing the operating state can be one or any combination of applied rotational speed of the hydrostatic machine 3, set working volume of the hydrostatic machine 3 and the pressure measured in S1.

The disclosure is not restricted to the described exemplary embodiment; instead, the for the amplitude of the oscillation typical for the cavitation can be established in any other way.

Alternatively, the amplitude of an oscillation with a specific frequency or a specific frequency range can for example be determined by determining the value of the Fourier coefficient at this frequency, which corresponds to the amplitude of the oscillation at this frequency, or by summing the values of the Fourier coefficients in a frequency band. A disadvantage of this method compared to the preferred exemplary embodiment of the disclosure is that the online calculation of Fourier transforms is computationally very expensive and, in the case of an unchanging sampling rate of the measured variables, there is the basic problem of the tradeoff between the time resolution of the amplitude of the oscillation and the frequency resolution of the Fourier transform. Furthermore, the amplitude of the oscillation could be established by band-pass filtering and a subsequent amplitude determination.

What is claimed is:

1. A method for detecting cavitation in a hydrostatic system, comprising:
capturing an oscillation typical for the cavitation from a measured variable captured over time;
establishing an evaluation variable for cavitation on the basis of the captured oscillation;
comparing the evaluation variable to a comparison value; and
capturing the pressure in the pressurized-means liquid of the hydrostatic system over time as measured variable.

2. The method according to claim 1, wherein if the hydrostatic system has a hydrostatic piston engine, the frequency typical for the cavitation is established on the basis of the number of pistons in the hydrostatic piston engine multiplied by the current rotational frequency of the hydrostatic piston engine or by the rotational-frequency range for which the hydrostatic piston engine is designed.

3. The method according to claim 1, wherein a variable which is proportional to the amplitude of the oscillation at the frequency typical for the cavitation is established from the measured variable.

4. The method according to claim 3, wherein:
the measured variable is subjected to band-pass filtering and amplitude determination, and
the band of the band-pass filtering contains the frequency typical for the cavitation.

5. The method according to claim 3, wherein:
the measured variable is smoothed over time,
a variable characterizing the absolute deviation of the measured variable from the smoothed measured variable over time is established, and
the smoothing value at a point in time is established by averaging over time a number of previously measured measured variables, which were measured over a period of time.

6. The method according to claim 5, wherein:
the variable characterizing the deviation of the measured variable from the smoothed measured variable is smoothed, and
the smoothed variable characterizing the deviation of the measured variable from the smoothed measured variable is established as the variable proportional to the amplitude of the oscillation.

7. The method according to claim 3, wherein the evaluation variable is established on the basis of the variable proportional to the amplitude of the oscillation.

8. The method according to claim 7, wherein the evaluation variable is established on the basis of the time during which the variable proportional to the amplitude of the oscillation is above an amplitude threshold.

9. The method according to claim 8, wherein the evaluation variable is established on the basis of the time during which the variable proportional to the amplitude of the oscillation is below a further amplitude threshold, which lies under the amplitude threshold.

10. The method according to claim 8, wherein the amplitude threshold and/or the further amplitude threshold are established on the basis of one of the variables from the captured pressure, an applied rotational speed of a hydrostatic machine, and a working volume set on the hydrostatic machine or a combination of these variables.

11. The method according to claim 7, wherein if the evaluation variable exceeds the comparison variable, the function of the hydrostatic system is restricted or the latter is switched off.

12. The method according to claim 1, wherein the measured values of the measured variable are not taken into account, or only taken into account to a limited extent, at times at which the measured variable exceeds an upper pressure threshold situated just below the pressure limitation of the hydrostatic system and/or when the measured variable drops below a lower pressure threshold that is a minimum requirement for the stable operation of the hydrostatic system and/or when the hydrostatic system is in a faulty operating state.

13. The method according to claim 1, wherein the hydrostatic system has a hydro-pneumatic storage and gas influx from a gas bubble of the hydro-pneumatic storage into the pressurized-means liquid is detected when cavitation is detected.

14. The method according to claim 1, wherein the pressure in the pressurized-means liquid on the high-pressure side of the hydrostatic system is captured over time as measured variable.

15. A control device, comprising:
an oscillation capturing device configured to capture an oscillation typical for the cavitation from a measured variable captured over time;
an evaluation device configured to (i) establish an evaluation variable for cavitation on the basis of the captured oscillation and (ii) compare the evaluation variable to a comparison value; and
a means for capturing the pressure in the pressurized-means liquid of the hydrostatic system over time as measured variable.
